(19) United States
(12) Patent Application Publication
(10) Pub. No.: US 2014/0305576 A1
(43) Pub. Date: Oct. 16, 2014

(54) LAMINATING FOIL

(71) Applicant: Bernd Loibl, Klettgau (DE)

(72) Inventor: Bernd Loibl, Klettgau (DE)

(73) Assignee: SWEDEX GmbH & Co. KG, Essen (DE)

(21) Appl. No.: 13/862,438

(22) Filed: Apr. 14, 2013

(51) Int. Cl. B32B 37/18; B32B 37/14

(52) U.S. Cl. CPC B32B 37/185; B32B 37/142; B32B 2307/31; B32B 2554/00
USPC 156/182; 428/347; 428/35.2; 428/349

(57) ABSTRACT

A laminating foil for weld encasing sheet material using two laminating foil sheets made from laminating foil and placed on top of one another, wherein the laminating foil is provided as a composite foil with a foil layer made from a transparent, in particular crystal clear plastic material with a glue layer made from a melt glue provided thereon, wherein the melt glue is transparent, in particular crystal clear, after laminating the sheet material, wherein the foil layer is made from a biodegradable plastic material, in particular a bio plastic material. The invention also relates to a use of the laminating foil.

### FIELD OF THE INVENTION

The invention relates to a laminating foil for encasing sheet material through welding using two laminating foil sheets made from the laminating foil which are arranged on top of one another, wherein the laminating foil is configured as a composite foil with a foil layer made from a transparent, in particular crystal clear plastic material, and a glue layer made from a melt glue arranged thereon, wherein the melt glue is transparent, in particular crystal clear after laminating the sheet material.

### BACKGROUND OF THE INVENTION

In order to protect sheet material, in particular valuable documents, it is known to encase the sheet material with a laminating foil on both sides through welding. This is performed in the non-industrial field, this means in an office environment or home environment through laminators that are typically configured as tabletop units. They include a housing in which a laminating device is arranged. Between an inlet opening on one side and an outlet opening on the other side of the housing, a pass-through channel extends through the housing, wherein the laminating device is associated with the pass-through channel. The laminating device typically includes at least one pair of rollers, sometimes also several pairs of rollers, including two laminating rollers respectively arranged on top of one another and forming a laminating gap between one another, wherein the laminating gap is adjusted so that the combination including the sheet material and the laminating foil is subjected to considerable pressure in the laminating gap. In hot laminators at least one of the laminating rollers is heated, typically both laminating rollers are heated and additional heating devices are provided. Thus, the combination made from sheet material and laminating foil is heated during pass-through so that the laminating foil due to the activation of the glue layer is glued together with the sheet material to be encased through welding. An embodiment for a laminator of the general type described supra can be derived from EP 2 329 950 B1.

Laminating foils for the purpose described supra are configured as composite foils, wherein one respective foil layer for example made from polyethylene or polypropylene is coated on its entire inner surface with a glue layer which is not glue capable or hardly glue capable at ambient temperature. Typically melt glue is used for the glue layer, wherein the melt glue is activatable through heat application in a temperature range of 100° to 200° C. Typically, an ethylene vinyl acetate copolymer (EVA) is used as a melt glue. When running through the laminator, the melt glue is heated so that it plasticizes and develops its gluing capability. The temperature required for this purpose is below the temperature which could in particular impair the transparency of the foil layer. When passing through the laminator, the initially typically opaque glue layer becomes transparent under heat and pressure so that the sheet material that is encased through welding is visible.

Typically a pocket shaped laminating foil is used for encasing the sheet material through welding, wherein two rectangular laminating foil sheets with identical sizes are placed on top of one another in alignment and are connected with one another at least at one edge, typically at two adjacent edges so that a laminating foil pouch is formed, wherein the connection is established in particular through welding. Laminating foil pouches of this type are generally used in personal applications and in office applications and can be derived for example from DE 201 00 328 U1, EP 2 329 950 B1, and DE 197 44 595 A1. Thus, the laminating foil sheets are placed on top of one another so that they contact one another with their glue layers, wherein the glue layers cover the inner sides of the laminating foil sheets.

Instead of using laminating pouches, it is known to use laminating foil cartridges in a laminating machine that is configured accordingly. In these laminating foil cartridges, long laminating foils are respectively wound on rollers. For the welding process, the sheet material is inserted into the laminator. In the laminator, the sheet material is then encased on both sides through pulling the laminating foil from the cartridges, this means the sheet material is coated and cut to size after heating and pressing. A laminator of this type can be derived from DE 100 04 486 A1.

### BRIEF SUMMARY OF THE INVENTION

It is an object of the invention to provide a laminating foil with improved properties. This object is achieved through a laminating foil for weld encasing sheet material using two laminating foil sheets made from laminating foil and placed on top of one another, wherein the laminating foil is provided as a composite foil with a foil layer made from a transparent, in particular crystal clear plastic material with a glue layer made from a melt glue provided thereon, wherein the melt glue is transparent, in particular crystal clear, after laminating the sheet material, wherein the foil layer is made from a biodegradable plastic material, in particular a bio plastic material.

Thus, it is a core idea of the invention to provide a laminating foil which has high ecological value due to its biodegradability. Surprisingly it has become apparent that bio polymers are capable of sustaining the severe exposure in the laminator without incurring any damage while still providing a firm and protective connection with the sheet material.

### DETAILED DESCRIPTION OF THE INVENTION

Biodegradability of plastic material used for the foil layers is provided according to DIN EN 13 432 when the plastic material is degraded after a defined time period under defined temperature, oxygen and humidity conditions in the presence of microorganisms or fungi into more than 90 percent water, carbon dioxide (CO2) and biomass.

According to the invention, preferably a bio plastic material is used, thus a plastic material that is based on renewable raw materials. The raw material can be sugar, sugar derivates, starch, starch derivates, cellulose, cellulose derivates and/or lignin. Instead or in combination therewith, the raw material can also be a polylactid acid (PLA) and/or a polyhydroxy fatty acid (PHF), in particular polyhydroxybutyrate (PHB) and/or polyhydroxyvalerate (PAV). Polylactides are biologically degradable polyesters and are polymerized from the monomer lactic acid, wherein lactic acid production is performed mostly using corn starch. Polyhydroxy fatty acids are thermoplastic polyesters generated under an influence of bacteria or fungi from sugar or starch. Alternatively thereto, the bio plastic material can also be a fossil raw material, for example polyester.

The biodegradable raw material shall be provided in the foil layer at least at 50%, preferably at least 80%, even better at least at 85, 90% or 95%. The remainder can include additives like stabilizers, antistatic agents or similar.

The laminating foil can be provided in rolls, for example as laminating foil cartridge when it is provided for use in a laminator that is accordingly configured (c.f. DE 100 04 486 A1). The laminating foil then has a length that is large enough so that a laminating foil cartridge suffices for a plurality of weld encapsulation processes. Instead laminating foil sheets can also be used that are cut from the laminating foil in identical sizes, wherein the sheet material is then arranged between the laminating foil sheets, wherein the glue layers are oriented towards one another. Thus, it is advantageous for handling when the laminating foil sheets are connected with one another at least at one edge, preferably even at two adjacent edges, so that a laminating foil pouch is formed (c.f. EP 2 329 950 B1, paragraphs [0015] and [0037], [0038]; DE 197 44 595 A1, column 2, lines 5 through 56 with FIGS. 1 and 2). A laminating foil pouch of this type facilitates parallel alignment of the edges of the sheet material and of the laminating foil sheets when inserting the sheet material between the laminating foil sheets and substantially prevents a sliding of the sheet material during subsequent handling for inserting into the laminator. With this respect better conditions can be achieved when the laminating foil sheets are welded together through three edges that are adjacent to one another. It is appreciated that the laminating foil sheets are placed on top of one another so that their glue layers contact one another, thus are adjacent to one another. Thus, it is sufficient when the laminating foil pouches for weld encasing sheet material are provided with a size of DIN A3 at the most, preferably DIN A4.

In a particularly preferred embodiment, the melt glue of the glue layer is at least partially, preferably entirely made from a thermoplastic biopolymer, for example a bio polyethylene and/or bio polypropylene. Both materials can be made from renewable raw materials, for example on the basis of sugar cane. Thus, it can be advantageous when the melt glue is a mix of the biopolymer and ethylene vinyl acetate. The portion of the ethylene vinyl acetate, however, should be as small as possible so that the laminating foil in its entirety is substantially biodegradable. In particular the percentage should be less than 50%, better less than 30%, in particular less than 20%. It is even better when the percentage of the ethylene vinyl acetate is less than 10%, in particular less than 5%.

It is furthermore an object of the invention to use the laminating foil for weld encasing, preferably individual sheets, in particular sheet material with DIN A3 format at the most, preferably DIN A4 format and/or DIN A5 format in that the sheet material is inserted between two laminating foil sheets of the laminating foil and the laminating foil sheets are then welded together with their surfaces through activating the glue layer under pressure and heat. Thus, in particular a laminating foil pouch should be used as described supra.

What is claimed is:

1. A laminating foil for weld encasing sheet material using two laminating foil sheets made from laminating foil and placed on top of one another,
wherein a laminating foil is provided as a composite foil with a foil layer made from a transparent or crystal clear plastic material with a glue layer made from a melt glue provided thereon,
wherein the melt glue is transparent or crystal clear after laminating the sheet material,
wherein the foil layer is made from a biodegradable plastic material or a bio plastic material.

2. The laminating foil according to claim 1, wherein the bio plastic material is produced using renewable raw material.

3. The laminating foil according to claim 2, wherein the renewable raw material includes at least one material selected form the group consisting of sugar, starch, starch derivates, cellulose, cellulose derivates and lignin.

4. The laminating foil according to claim 2, wherein the renewable raw material is a polylactid acid (PLA) or a polyhydroxy fatty acid (PHF) or polyhydroxybutyrate (PHB) or polyhydroxyvalerate (PAV).

5. The laminating foil according to claim 1, wherein the bio plastic material is a fossil raw material.

6. The laminating foil according to claim 1, wherein the raw material is provided as a base material in the foil layer between 50% and 95% by weight.

7. The laminating foil according to claim 1,
wherein two identical laminating foil sheets made from the laminating foil are connected with one another in a portion of at least one edge, or in a portion of at least two edges joining one another so that a laminating foil pouch is formed,
wherein the glue layers are adjacent to one another.

8. The laminating foil according to claim 7, wherein the laminating foil pouch is sized for weld encasing sheet material with a maximum size of DIN A3 or DIN A4.

9. The laminating foil according to claim 1, wherein the melt glue is partially or entirely made from a thermoplastic biopolymer.

10. The laminating foil according to claim 9, wherein the biopolymer is a bio polyethylene or a bio polypropylene.

11. The laminating foil according to claim 9,
wherein the melt glue is a mix of the bio polymer and the ethylene vinyl acetate,
wherein a percentage of the ethylene vinyl acetate is less than 50% by weight.

12. A use of the laminating foil according to claim 1 for weld encasing sheet material,
wherein the sheet material is placed between two laminating foil sheets of the laminating foil and the laminating foil sheets are then welded together with their surfaces by activating the glue layer under pressure and heat.

13. The use according to claim 12, wherein a laminating foil pouch according to claim 8 is used.

14. The laminating foil according to claim 1, wherein the bio plastic material is polyester.

15. The laminating foil according to claim 1,
wherein two identical laminating foil sheets made from the laminating foil are welded together in a portion of at least one edge, or in a portion of at least two edges joining one another so that a laminating foil pouch is formed, and
wherein the glue layers are adjacent to one another.
